(19) United States
(12) Patent Application Publication
(10) Pub. No.: US 2008/0128966 A1
(43) Pub. Date: Jun. 5, 2008

(54) Damping ring for vibration isolation

(75) Inventor: Hsieh-Liang Tsai, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/633,422

(22) Filed: Dec. 5, 2006

(51) Int. Cl. F16F 7/104

(52) U.S. Cl. 267/140.3

(57) ABSTRACT

A damping ring is provided for isolating vibration between a fixing member and a structure. The damping ring includes a body and a protruding lip formed on the body. The body is installed on the structure and has a through hole opened along the central axis of the body, and the through hole is provided for the fixing member to be inserted therein. The protruding lip is formed on the edges of a opening of the through hole and surrounds the opening, and the protruding lip extends outwardly along the central axis of the body, and extends inwardly along the radial direction, so as to contact with the fixing member, such that a gap is formed between the fixing member and the body instead of directly contacting the fixing member with the body, thus vibration transmitted between the fixing member and the structure is cushioned and isolated.

### BACKGROUND OF THE INVENTION

1. Field of Invention

The present invention relates configuration of damping ring, and more particularly, to a damping ring for effectively isolating and cushioning the vibration.

2. Related Art

When a fan or a motor within the electronic device is running, the vibration generated by the fan or the motor is transmitted outwardly, which causes the structures in the computer, such as a circuit board, to vibrate and thus being damaged. Besides the vibration generated by the vibration sources such as the fan or the motor, when the electronic device is moved or crashed, the impact or vibration generated by an external force will also be transmitted to the structures.

Referring to FIGS. 1, 2 and 3, in order to isolate and cushion the vibration, the currently used damping ring 10 for vibration isolation is installed in a fixing hole 12 formed on a structure 14, for a fixing member 18, such as a bolt, to pass through, being inserted in to fix the structure 14 on a base 16, thus the vibration is isolated and cushioned through the damping ring 10, so as to prevent the crash, vibration occurred to the base 16 caused by the external force from being transmitted to the structure 14 through the fixing member 18, or prevent the vibration occurred to the structure 14 generated by the vibration source from being transmitted to the base 16 or other structures (not shown) through the fixing member 18.

The damping ring 10 in the prior art is made of rubber, which isolates and cushions vibration by way of being distorted and compressed. When the vibration is transmitted between the structure 14 and the fixing member 18, it is transmitted after the damping ring 10 is compressed along the radial direction. Although the rubber is distorted for cushioning, the acting method is to compress the solid portion of the whole damping ring 10, so that the radial stiffness of the damping ring 10 in the vibration transmitting path is excessively high, and the distortion is small, thus the energy of vibration cannot be effectively isolated and cushioned through the damping effect.

Moreover, when the damping ring 10 is compressed axially, the solid portion of the whole damping ring 10 along the axial direction is directly compressed, so that the damping ring 10 also has an excessively high axial stiffness and a small distortion, thus the vibration cannot be effectively isolated and cushioned through the damping effect. Moreover, the damping ring 10 is directly contacted with the fixing member 18, which lacks of cushioning space, therefore, when the vibration is transmitted through the fixing member 18, there is no space for the relative displacement between the fixing member 18 and the damping ring 10. Furthermore, the damping ring 10 has the problems of having an excessively high stiffness and a small distortion, thus the vibration is still directly transmitted to the structure 14 without being absorbed by the damping effect produced by the material of the damping ring 10, therefore, the buffering and isolating effect of the damping ring 10 is not desirable.

### SUMMARY OF THE INVENTION

Since there is no cushioning space between the current damping ring and the fixing member inserted therein, and the damping ring has the problem of having excessively high stiffness, the cushioning and isolating performance is poor. In view of this problem, the object of the present invention is to providing a damping ring, which is used for forming a gap between the damping ring and the fixing member inserted therein, and reducing the stiffness of the damping ring, so as to improve the damping effect and enhance the vibration isolating and cushion effect.

In order to achieve the above object, the present invention provides a damping ring, which is installed on a structure for a fixing member to be inserted therein, so as to fix the structure on a base via the fixing member, and the vibration transmission between the fixing member and the structure is isolated. The damping ring includes a body and a at least one protruding lip formed on the body, wherein the body is installed on the structure and has a through hole opened along the central axis of the body, and the through hole has two opening each respectively corresponding to each end surface of the body for the fixing member being inserted therein. The protruding lip is formed on the edge of at least one of the openings and surrounds the opening. The protruding lip extends outwardly along the central axis of the body, and extends inwardly along a radial direction of the body, so as to contact with the fixing member, such that a gap is formed between the fixing member and the body instead of directly contacting the fixing member with the body, thereby thus vibration transmitted between the fixing member and the structure is cushioned and isolated. Therefore, there is a larger space for relative displacement between the fixing member and the damping ring, and the distortion of the damping ring is increased during the vibration transmission, so as to produce a damping effect effectively to cushion and isolate the vibration.

In the present invention, the protruding lip and the gap can effectively reduce the radial stiffness and the axial stiffness of the damping ring. When the vibration occurs, the protruding lip makes the damping ring to have a large distortion, so as to improve the whole damping effect of the damping ring, and to disperse the vibration to other parts, thereby increasing the whole distortion of the damping ring, thus, the damping effect of the damping ring can be completely achieved to absorb the kinetic energy of the vibration. Meanwhile, a gap is also formed between the damping ring and the fixing member for producing a large relative displacement there-between, and the distortion of the damping ring is also enhanced, thus, the damping effect is effectively improved, and the buffering and isolating effect is enhanced.

The detailed features and advantages of the present invention will be illustrated below in the detailed description, which is sufficient for any persons skilled in the art to appreciate the technical content of the present invention and implement it accordingly, and any persons skilled in the art will easily appreciate the objectives and advantages of the present invention from the disclosure of the specification, claims, and drawings.

The above description of the content of the present invention and the following description of the implementation of the present invention are provided for demonstrating and explaining the principle of the present invention, and providing a further explanation of the claims of the present invention.

### BRIEF DESCRIPTION OF THE DRAWINGS

The present invention will become more fully understood from the detailed description given herein below for illustration only, which thus is not limitative of the present invention, and wherein:

FIG. 1 is a 3D view of a damping ring in the prior art;

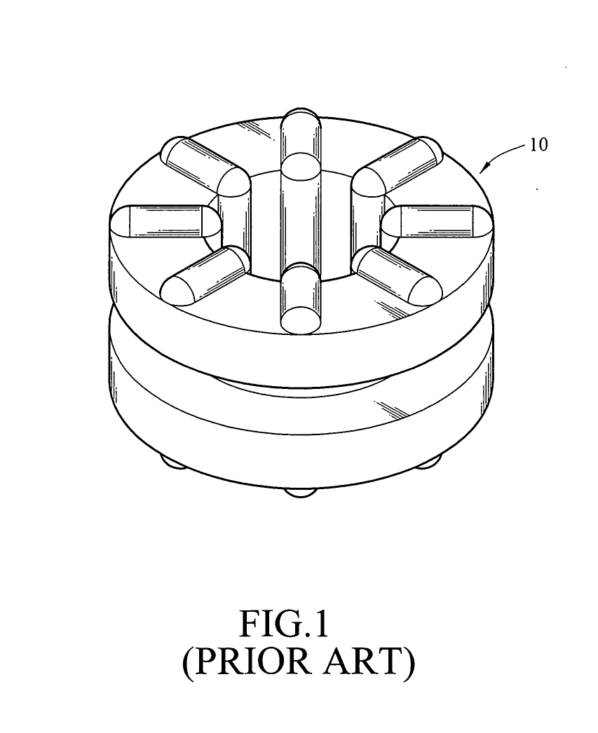

FIG. 2 is a side sectional view of the damping ring in the prior art;

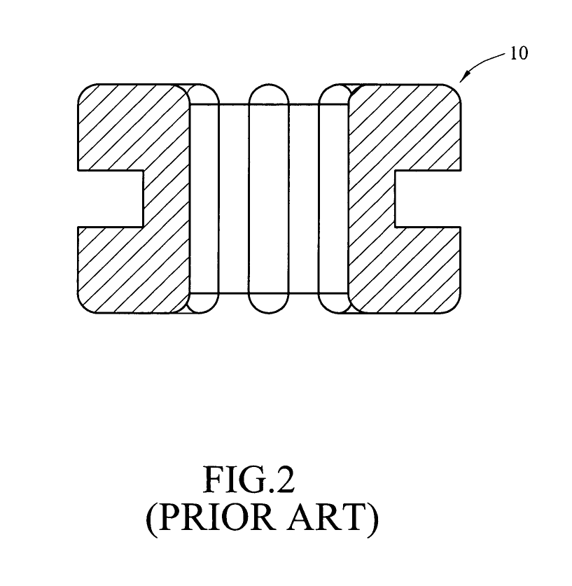

FIG. 3 is a schematic view of an embodiment of the damping ring in the prior art;

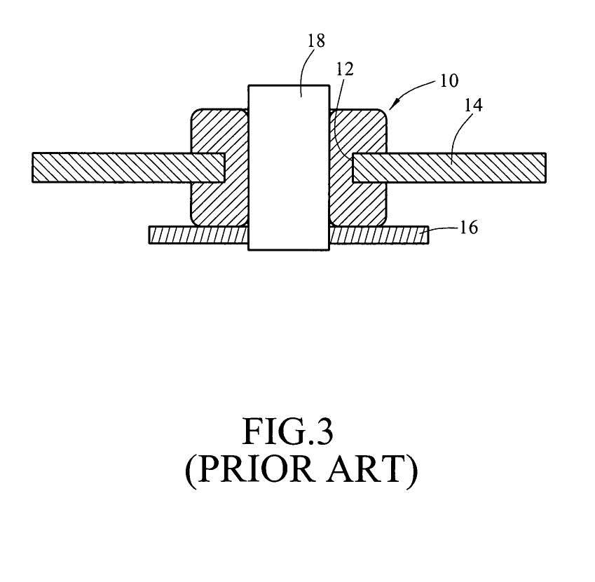

FIG. 4 is a structural sectional view of a damping ring of the present invention;

FIG. 5 is a 3D view of the damping ring of the present invention;

FIG. 6 is a schematic view of the damping ring of the present invention when being mounted; and

FIG. 7 is a schematic view of an embodiment of the damping ring of the present invention.

### DETAILED DESCRIPTION OF THE INVENTION

The present invention is directed to preventing the structures such as the circuit board in the computer from being damaged due to the vibration produced by the vibration source, or due to the impact produced by moving or crashing the electronic device.

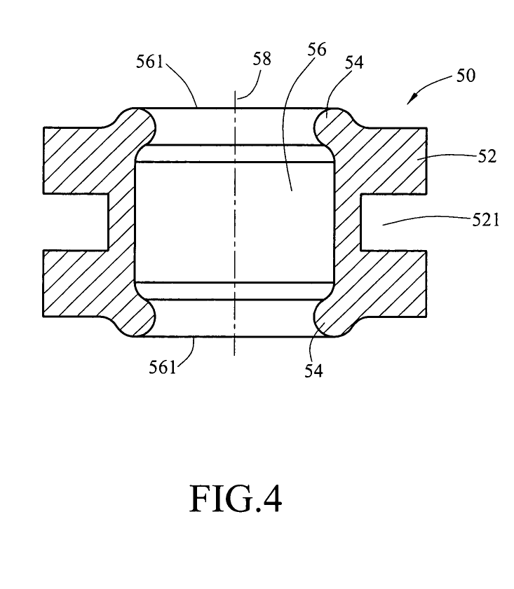

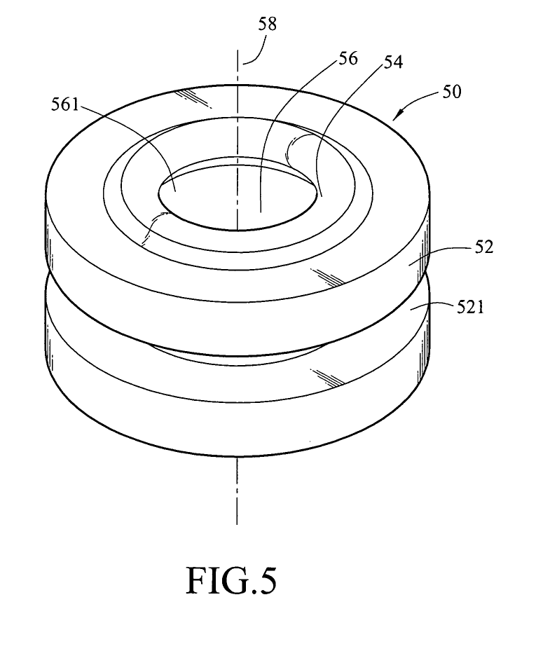

As shown in FIGS. 4 and 5, a damping ring 50 is disclosed in this embodiment installed on a structure 60 and for a fixing member 80 being inserted to fix the structure 60 on a base 70. The damping ring 50 includes a body 52 and protruding lips 54 formed on two end surfaces of the body 52.

The body 52 is cylinder-shaped and has a through hole 56 opened along the central axis 58 of the body 52. The through hole 56 has two opening 561 each respectively corresponding to each end surface of the body 52. The two end surfaces of the body 52 are respectively provided with a protruding lip 54 that is annular-shaped. Each protruding lips 54 is formed on the edge of the corresponding opening 561 and surrounds the edge of the opening 561. Each of the protruding lips 54 extends outwardly along the central axis 58 of the body 52, and extends inwardly along the radial direction of the body 52, thus, the diameter of a region surrounded by the front side edge of the protruding lip 54 is smaller than that of the through hole 56. The body 52 further has an outside circle groove 521 formed on a peripheral of the whole body 52.

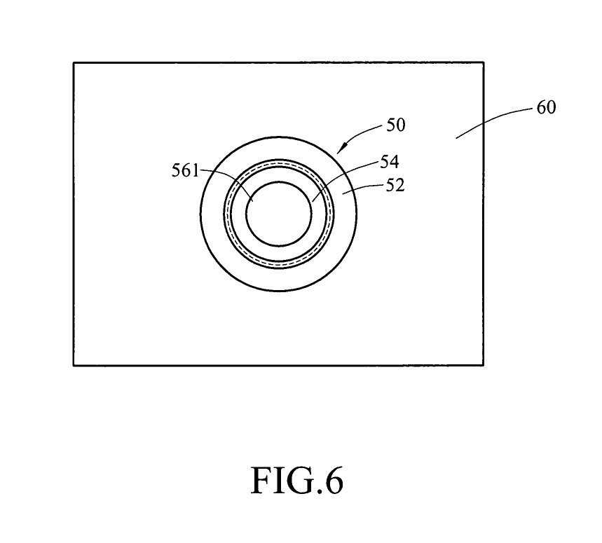

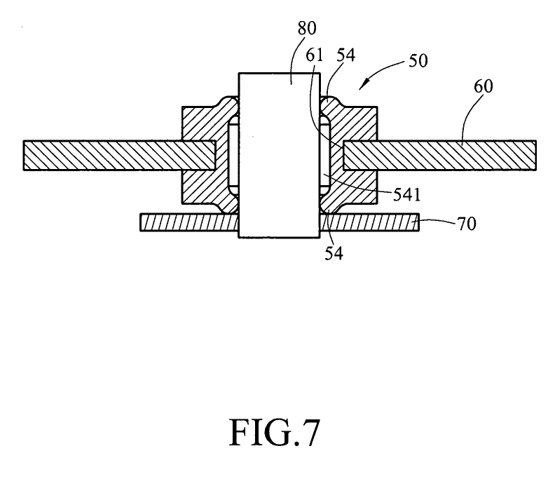

As shown in FIGS. 6 and 7, the body 52 is installed in a fixing hole 61 of a structure 60, so that the edge of the fixing hole 61 is embedded into the outside circle groove 521, thus, the damping ring 50 is fixed on the structure 60.

The fixing member 80, for example, a bolt, is inserted into the through hole 56 of the body 52 along the direction of the central axis 58. The shape and size of the cross section of the fixing member 80 are matched with the size of the region surrounded by the protruding lip 54, such that the fixing member 80 is contacted with the protruding lip 54 to produce a tightly matching relationship, thus, the body 52 is fixed on the fixing member 80 by the protruding lip 54. The fixing member 80 is then fixed on the base 70, such that the structure 60 is fixed above the base 70. At this time, the body 52 and the fixing member 80 are only contacted with a protruding lip 54 there-between, thus, a gap 541 is formed between the fixing member 80 and the body 52 instead of directly contacting the fixing member 80 with the body 52.

When a vibration is produced by a vibration source (not shown) disposed on the structure 60, the vibration is transmitted to the damping ring 50 via the structure 60, and then transmitted to the base 70 via the fixing member 80. At this time, the structure 60 moves the body 52 of the damping ring 50 firstly. Since the body 52 and the fixing member 80 are only contacted with the protruding lip 54 there-between, the vibration is transmitted to the fixing member 80 via the protruding lip 54. Once the vibration occurs, the presence of the gap 541 enables the body 52 to move relatively to the fixing member 80, thus causing a distortion of the protruding lip 54. Meanwhile, the gap 541 also provides a cushioning space for the distortion of the body 52 instead of simply being compressed, thus, the radial stiffness of the damping ring 50 is reduced while the distortion is increased, thus, the damping effect of the damping ring 50 is improved, the kinetic energy of the vibration is absorbed and dissipated, and the vibration transmitted to the base 70 through the fixing member 80 is reduced.

When the vibration is transmitted from the base 70, the vibration unavoidably presses the protruding lip 54 along the central axis firstly. Meanwhile, since there is a gap 541 between the base 70 and the damping ring 50, the protruding lip 54 is pressed and distorted towards the gap 541, and the distortion is increased as the vibration force increases. Furthermore, the gap 541 provides a cushioning space to increase the distortion of the damping ring 50, and to reduce the axial stiffness of the damping ring 50, thus improving the damping effect and weakening the vibration. Therefore, the design of the protruding lip 54 disperses the axial vibration from the base 70 into other parts, thus effectively reducing the vibration force.

The damping ring in the prior art is directly contacted with the fixing member without any cushioning space there-between, thus, the damping ring has a high stiffness and a small distortion, and the vibration is directly transmitted between the fixing member and the damping ring, so that the vibration cannot be effectively consumed by the damping effect. The present invention uses the protruding lips 54 on the end faces of the body 52 to form a gap 541 between the damping ring 50 and the fixing member 80. The gap 541 provides the damping ring 50 with a large cushioning and distorting space when suffered from the vibration transmitted from the structure 60, which enhances the distortion of the damping ring 50, and thus effectively improving the damping effect. Meanwhile, the constitution of the protruding lip 54 is used to disperse the vibration force into other directions, thus effectively weakening the transmission of the vibration force.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A damping ring for vibration isolation, comprising:
a body, having a through hole along the central axis of the body, wherein the through hole has two openings each corresponding to each end surface of the body respectively; and
a protruding lip, formed on at least one edge of the openings and surrounding the opening, wherein the protruding lip extends outwardly along the central axis of the body, and extends inwardly along a radial direction of the body.

2. The damping ring for vibration isolation as claimed in claim 1, wherein the diameter of a region surrounded by the front side edge of the protruding lip is smaller than that of the through hole.

3. The damping ring for vibration isolation as claimed in claim 1, wherein the body further comprises an outside circle groove formed on a peripheral of the body.
